(19) United States
(12) Patent Application Publication
(10) Pub. No.: US 2008/0267018 A1
(43) Pub. Date: Oct. 30, 2008

(54) DISC TRANSPORT AUTO-CALIBRATION

(75) Inventors: Dale K. Kubin, Murrieta, CA (US); Nathan P. Scherdin, Poway, CA (US)

Correspondence Address: DOBRUSIN & THENNISCH PC, 29 W LAWRENCE ST, SUITE 210, PONTIAC, MI, 48342, US

(73) Assignee: Xlnt Idea, Inc.

(21) Appl. No.: 12/061,906

(22) Filed: Apr. 3, 2008

Related U.S. Application Data
(60) Provisional application No. 60/909,774, filed on Apr. 3, 2007.
(60) Provisional application No. 60/946,556, filed on Jun. 27, 2007.

(51) Int. Cl. G11B 7/085

(52) U.S. Cl. 369/30.64

(57) ABSTRACT

The present invention provides a media device apparatus having an improved design for auto-calibration providing efficient operation and improved engagement to one or more storage discs. In one aspect, the present invention provides a disc transport movable along at least one axis, one or more media device components including an engagement area, and a calibrating device for aligning the disc transport with the engagement area, the calibrating device including a first member associated with the disc transport and a second member associated with the media device component, wherein either the first member or the second member moves along a first axis until a calibration position is sensed, which is at a known distance from the engagement area. In another aspect, the present invention provides a method for calibrating at least one of the disc transport and the one or more media device components along an engagement axis.

### CLAIM OF PRIORITY

The present invention claims the benefit of the priority of the filing date of U.S. Provisional Application Ser. No. 60/909,774 filed Apr. 3, 2007 and 60/946,556 filed Jun. 27, 2007, which are herein incorporated by reference for all purposes.

### TECHNICAL FIELD

The field of the present invention relates to disc transport devices and more particularly to disc transport devices configured with an auto-calibration feature adapted for selectively locating disc engagement areas for alignment thereof.

### BACKGROUND OF THE INVENTION

Media device manufacturers currently provide consumers with media devices configured for processing media (such as storage discs, or otherwise). Such processing requires the use of a disc transport for engagement of storage discs and movement to the one or more media components of the media devices for processing therein. A disc transport device handles media by moving to a preprogrammed location to pick or place media. The media is usually in a fixed location which must be engaged with relative accuracy. Typically, since each disc transport robot is slightly different due to manufacturing tolerances, most systems will require a user calibration menu to adjust these pick points. Recently, media devices manufacturers have attempted to improve the features of disc transport devices for the engagement of a disc with minimal user interaction.

However, the media devices have failed to provide a unit having an efficient auto-calibration feature. Current media devices used in the field to process storage discs are received by the end-user having misalignments caused by handling usually associated with the shipping of the media device and/or to compensate for temperature variances based on the geographic location of the disc transport operation such that the changes in temperature may affect the fluidity of movement about the device. These media devices fail to cope with misaligned components such as the disc transport, the movable tray of a recording device, a disc storage receptacle, or otherwise and often require the user to send the media device back to the manufacturer for repairs, which may cost the end-user additional money and more importantly, time.

Furthermore, over time, many subcomponents of the media devices, (e.g., belts tend to stretch, parts shift slightly), begin to wear, which additionally may cause misalignment of the disc transport. Therefore, there may be a need for a media device that can auto-calibrate by adjusting to the changes within the media device over time.

In view of the forgoing, there is a need for a media device, which advantageously can auto-calibrate a misaligned component of the media device, thereby enabling future engagement and disengagement needs for the media device.

### SUMMARY OF THE INVENTION

The present invention overcomes the drawbacks of the prior art by providing an auto-calibrating media device having an improved design, which provides more efficient operation and orientation of the device's components for the handling and use of disc media. As such, this new design further provides an economically priced media device, which is advantageously sized for an individual use, small business, or otherwise, and which is more user friendly than prior art media devices.

Auto calibration of the components of a media device are designed to compensate for misalignment caused by handling usually associated with the shipping of the media device, or otherwise. Auto-calibration will allow an end-user to recalibrate the media device instead of sending the media device back to the manufacturer for repairs, which may cost the end-user additional money and more importantly, time.

In one aspect, the present invention provides a disc transport movable along at least one axis, one or more media device components including an engagement area, and a calibrating device for aligning the disc transport with the engagement area, the calibrating device including a first member associated with the disc transport and a second member associated with one or more media device components, wherein either the first member or the second member moves along a first axis until a calibration position is sensed, which is at a known distance from the engagement area.

In another aspect, the present invention is directed to a method for calibrating a misaligned disc transport and/or one or more media device components with respect to an engagement axis by providing a disc transport for movement along at least one axis, one or more media device components having an engagement area adapted to receive at least one disc, a controller for controlling the functions of the media device and a calibrating device for aligning at least one of the disc transport and the one or more media device components along an engagement axis. The calibrating device includes a first member associated with the disc transport and a second member associated with the one or more media device components. Calibrating at least one of the disc transport and the one or more media device components by moving either the first member, the second member, or both until a calibration position is sensed and determining a calibration setting for the disc transport, the one or more media device components, or both along an engagement axis.

### BRIEF DESCRIPTION OF THE DRAWINGS

FIG. 1 is a perspective view of one aspect of the present invention.

FIG. 2 is a perspective view of another aspect of the present invention.

FIG. 3 is a perspective view of another aspect of the present invention.

FIG. 4 is a perspective view of another aspect of the present invention.

FIG. 5 is a perspective view of another aspect of the present invention.

### DETAILED DESCRIPTION OF THE INVENTION

The present invention provides a media device and method for calibrating a misaligned disc transport for the engagement of one or more storage devices including, but not limited to: compact discs, digital video discs, the like, combinations thereof or otherwise. More specifically, the media device (e.g., disc-publishing device) is adapted to provide an auto-calibration feature for calibrating a misaligned disc transport by locating a disc engagement area 20, aligning the disc transport therewith, and storing the data (e.g., calibration setting) for future engagement of discs in the engagement area the disc transport. Advantageously, the improved media device comprises the auto-calibration feature, and is further adapted for engaging and transferring storage discs to one or more media components for processing by way of printing, recording, and/or otherwise to a disc as disclosed in U.S. application Ser. No. 11/335,381 entitled “Printer” and is herein incorporated by reference for all purposes.

Accordingly, in one exemplary configuration, the present invention meets the above needs by providing a calibration feature for the alignment of the disc transport during engagement and/or disengagement of at least one storage disc from a source location or to a target location. The disc transport includes an engagement mechanism that is capable of engaging or disengaging storage discs prior to or after transportation, respectively. Furthermore, the disc transport in combination with the engagement mechanism allows for locating one or more engagement areas for engagement of disc therein. The engagement areas may be located about one or more components of the media device that are in communication with the disc transport such as printing assemblies, recording devices, copying devices, playing devices, storage areas, combinations thereof or otherwise.

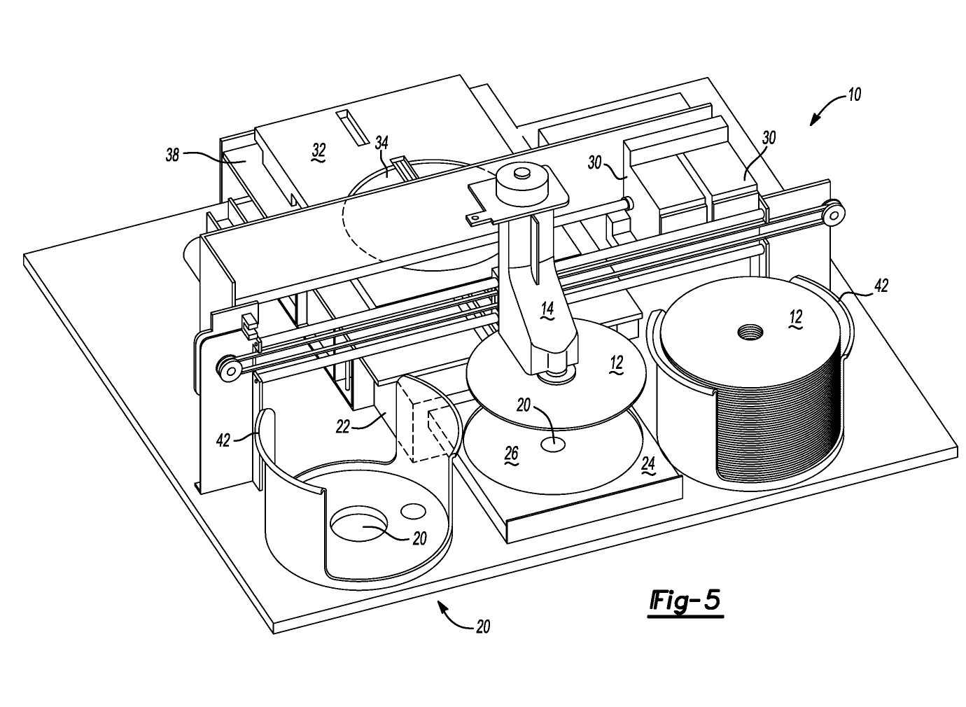

Referring to the drawings, exemplary embodiments and features of the present invention are shown. In one embodiment as shown in a media device 10, (FIG. 5), the present invention provides a disc transport 14 adapted to engage and move one or more discs 12, preferably one at a time. The disc transport has independent movement capabilities and is controlled by a controller, which may be attached to the disc transport or may be part of another component of the media device.

The disc transport is adapted to move along a substantial portion of a first slide member for movement along at least one axis. The first slide member may comprise of any member adapted to guide an attached member along a portion of its length, width or otherwise. Suitable guiding feature include tracks, shafts, rails, grooves, the like or otherwise. Suitable elongated members include shafts, rods, beams, rails, the like or otherwise.

Accordingly, the device further includes drive means linkably attached to the disc transport, via a linkage or otherwise, to provide a suitable force to move the disc transport to various points along the first slide members. Suitable drive member may include, but are not limited to, a stepper motor or other suitable drive members used for moving a disc transport component along a bearing surface or the like. Suitable linkages include, but are not limited to, belts, cables, chains, screws, the like or otherwise. In a preferred embodiment, the linking mechanism comprises a belt. However, it should be appreciated that numerous types of drive assemblies and linkages are available and may be used, as are commonly utilized in the design of inkjet printers.

As previously mentioned, the disc transport further includes an engagement mechanism adapted to selectively engage a disc portion. The engagement mechanism may include a first finger and a corresponding second finger, which when combined, the first and second fingers form a diameter that generally corresponds to the disc hole 18 formed in the disc and may be adapted to move relative to each other. By way of example, in a first position, the fingers may be in a closed position wherein the resulting diameter of the fingers may be less than the diameter of the disc hole. Accordingly, the fingers can move into the disc hole without substantial interference. In a second position, the fingers may be separate so as to form a diameter that may be equal to or greater than the diameter of the disc hole such that the fingers engage the inner walls of the disc hole to prevent the disc from disengaging from the disc transport. It should be appreciated that the fingers may be configured to engage the interior walls of the disc hole and optionally form a friction fit through an application of i) pressure by the fingers, ii) support from the underside of the disc using flanges on one or both fingers, or otherwise, or combinations thereof. Optionally, the first finger, the second finger, or both may include a tapered end portion for assisting in the alignment and insertion of the fingers into the disc hole. Movement of the first and second fingers, with respect to one another, may be achieved using any suitable drive means. Suitable drive means include, but are not limited to, mechanical, electrical, pneumatic, magnetic, or otherwise.

In view of the foregoing, it should be appreciated that upon engagement with a disc, (e.g., movement of the fingers from a first position to a second position), the disc may be moved along the first slide member or otherwise to different regions of the media device. Accordingly, when the disc transport reaches a desired location (e.g., engagement area), the engagement fingers move back to the first position, thereby resulting in the disengagement of the disc with the engagement mechanism.

The disc transport may be further configured with means for movement along one or more slide members such as a second slide member for movement along one or more axes. When included, the disc transport may be movable along the second slide member in a direction that is generally perpendicular to the first slide member. Preferably, this perpendicular movement is generally vertical with respect to the media device; however, other directions are within the scope of the invention. Advantageously, this movement allows the engagement mechanism to be lowered over a disc for engagement or alignment with the same. Subsequently, the disc may be lifted away from the disc source location and moved along the first slide member, to a desired location. Upon arrival to the desired location (e.g., a print location, record location, final destination or otherwise), the disc may be lowered to a select height and disengaged for further processing of the disc or otherwise. Additional axes of movement for the disc transport are appreciated such as movement that is diagonal, rotational, otherwise, or combinations thereof in addition to the X-axis and Y-axis, (horizontal axes), the Z-axis, (vertical axis) or optionally the R-axis (radial axis), as discussed herein.

Similar to the movement along the first slide member, the movement along the second slide member of the disc transport may be achieved using any suitable drive means. Suitable drive means include, but are not limited to, mechanical, electrical, pneumatic, magnetism, the like means or otherwise. It should be appreciated that the drive assembly may be activated in an opposite direction (e.g., from the second to the first position) to return the disc transport to its original, previous, or other position. It should be appreciated that the distance between vertical positions of the disc transport may vary due to the changing height of stacked discs, located at the disc storage region or otherwise. Accordingly, the drive means is adapted to align one or more discs at various heights as discussed herein for calibration thereof.

In a preferred embodiment, disc transport is controllable through a controller. The controller may be included with the disc transport, e.g. not incorporated within the device, or alternatively, the controller of the device may be included as a component of the device. However, in a preferred embodiment, the controller is adapted to receive a signal from a source, such as a computer or otherwise, such that function of the print device is based upon the received signal. Furthermore, preferably the controller causes synchronized operation of the components of the device (e.g., printing, recording, movement or otherwise) to maximize efficiency by minimizing cycle time of any task to be performed.

Advantageously, the disc transport may further comprise one or more sensors 18. The sensor (e.g., mechanical, electromagnetic, optical, or otherwise) is configured to sense a condition (e.g., interact) and to provide a condition signal corresponding to the sensed condition. The controller interprets the condition signal and controls the disc transport, the engagement mechanism, the one or more media components, or otherwise, or any combination thereof according. For example, the sensor may be utilized for determining when the engagement mechanism is in a desired (e.g., predetermined) location for locating an engagement area and/or engagement axis, aligning a disc, or otherwise. Suitable sensors include, but are not limited to, pressure sensor, optical sensors, electro mechanical sensors, Hall Effect sensors or otherwise. More specifically, the sensor may be configured to sense a condition so as to provide a condition signal corresponding of the sensed condition to the controller to determine the necessary action(s) to be taken. For example, in one embodiment, the sensor may be located on or proximate to the flanges extending from the fingers of the engagement mechanism. The sensors may be configured to provide a condition signal when the engagement mechanism is flush or partially disposed within the disc hole so that the necessary action to be taken may be to move the first and second fingers into the opened position to engage the disc. In another example, the sensor may be located on the disc transport to determine the position of the disc transport (e.g. engagement mechanism) and one or more components of the media device with respect to one another for calibration and/or alignment thereof, as discussed herein

The present invention may be adapted to work with one or more media components of a media device for performing multiple tasks to create a final disc product. Of these tasks, one particularly useful task includes recording information to the disc for subsequent retrieval. Such information may include music, videos, files, or other types commonly recorded through optical means. Accordingly, the media device may further include a media component such as a digital recording device adapted to record information to a disc. The recording device may be configured to receive a disc from the disc transport, subsequently record information to the disc and make the disc available to the disc transport for subsequent tasks or otherwise. It should be appreciated that the information to be recorded to the disc may originated from another component, input port connected to an external device, or otherwise.

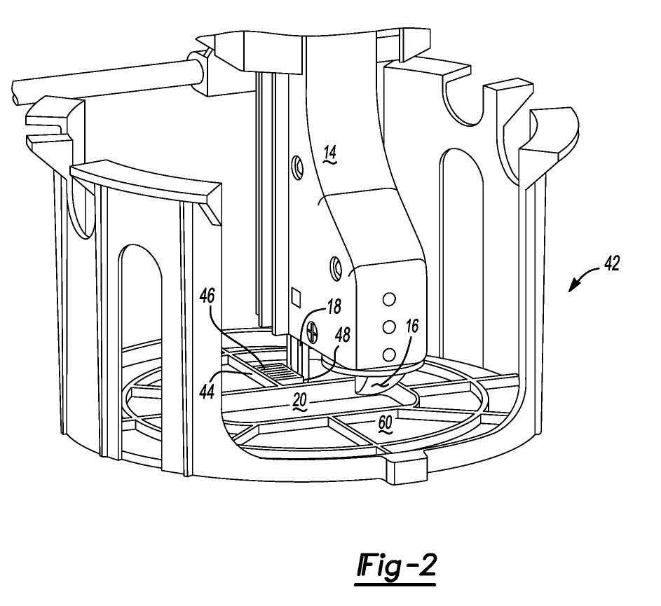

Referring to FIGS. 2-4, a suitable recording device, 22 for recording digital information to a disc is illustrated. The recording device includes a movable recording tray 24 (e.g., an engagement area), which is adapted to reside in a retracted closed position, wherein information may be recorded, and extend to a second open position for receiving and/or providing a disc to the engagement mechanism of the disc transport. However, upon the step of removing a processed disc from the media devices, the recording tray may also be configured for incremental movement, which allows for a plurality of intermediate positions for the recording tray that are between a “fully extended” position and a “fully retracted” position. It is further appreciated, that the recording tray may extend to positions beyond the “fully extended” and “fully retracted” positions, or otherwise. It should be appreciated that movement of the movable recording tray may be achieved using common techniques used in compact disc and digital video disc players and recording devices, or otherwise.

In operation, the recording device extends the movable recording tray to an extended open position for receiving a disc from the engagement mechanism of the disc transport. If not already located there, the disc transport moves an engaged disc to a position substantially over the tray location of the recording device, such tray location has been preprogrammed within the controller, controlling the disc transport. The disc transport lowers the disc into the movable recording tray, and the engagement mechanism releases the disc. Upon completion of recording to the disc, the movable recording tray extends to an extended open position so that the engagement mechanism of the disc transport can retrieve the disc for further processing or otherwise.

In one embodiment, the movable recording tray may be configured with a recess 26 having a center adapted to be substantially concentrically aligned with a disc placed therein. Accordingly, in the extended open position, the movable recording tray is adapted to receive a disc from the engagement mechanism. For example, it is contemplated that when the movable recording tray is in a fully extended open position, the recess portion is generally concentrically aligned with the center of the disc portion, (inner ring), attached to the disc transport located thereabove. In this respect, the disc transport aligns the disc to the center portion of the movable recording tray and places the disc into the tray. Once the disc has been lowered into the movable recording tray, the disc transport raises the engagement mechanism above the disc and the movable recording tray is fully retracted Another useful task that may be performed with the present invention includes printing a design, text or otherwise to a disc for identification purposes, or otherwise.

Accordingly, the media device may further include a media component such as a print assembly 28 adapted to print to a disc using common printing techniques (e.g., inkjet laser or otherwise). In a preferred embodiment, the print assembly includes one or more print head and ink cartridges having colors commonly associated with inkjet printing (e.g., black, white, reds, blues, greens, combinations thereof as otherwise). The print heads 30 may be mounted to a print slide member, which preferably extends along at least a portion of the housing and is mounted or otherwise secured thereto. It should be appreciated that the print slide member may include any of the features of the first and second slide members. The mounting of the print assembly to the print slide member provides movement along a print axis, but does not interfere with the movement of the disc transport located on the first slide member. It should be appreciated that the print head further includes a suitable drive means and linkages for movement of the print head along the print slide member. Suitable drive means and linkages may include any of the devices used for movement of the disc transport or any other suitable drive and/or linkage found in the art of media devices and more particularly the drive configuration of print heads.

Advantageously, the print heads are adapted to print to a disc portion located within the print tray 32. Suitable print heads that can be used with the present invention can be found in the field of inkjet printing. However, printing to a disc using laser or thermal print technology is also within the present invention. In fact, it is contemplated that laser-printing technology may be used to print to a disc, which may include color. Regardless to the print means used, it should be appreciated that the media device may print using any of the colors or color combinations found in the print industry.

The print assembly further includes a print tray (e.g., engagement area) adapted to receive a disc and provide movement thereabout, which preferably is substantially perpendicular to the movement of the printer heads. Advantageously, the print tray is adapted for movement along a print axis to effectuate printing. For example, the print tray may be moveable to a first position, which is fully extended and a second position, which is fully retracted. It should be appreciate that during printing, the print tray may move between the first and second position to provide print capability throughout the entire disc located within the print tray. However, upon the step of removing a processed disc from the media devices, the print tray may also be configured for incremental movement, which allows for a plurality of intermediate positions for the print tray that are between a “fully extended” position and a “fully retracted” position. It is further appreciated, that the print tray may extend to positions beyond the “fully extended” and “fully retracted” positions, or otherwise.

The print tray may be configured with a recess 34 having a center adapted to be substantially concentrically aligned with a disc placed therein. Accordingly, in the extended position, the tray is adapted to receive a disc from the disc transport. For example, it is contemplated that when the disc tray is in a “fully extended” position, the recess portion is concentrically aligned with the center of the disc portion attached to the disc transport located thereabove. In this respect, the print tray is positioned so that the center portion of the print tray is in alignment with the engagement mechanism, wherein the disc transport proceeds to place the engaged disc into the print tray. In one configuration, placement of the disc into the print tray comprises lowering the engagement mechanism to the position just above the print tray, releasing the disc into the tray, and raising the engagement mechanism to a first (e.g., original) position. As previously discussed, the disc transport or engagement mechanism may be calibrated to align the same with the print tray, the recording tray, or otherwise.

Movement of the print tray can be effectuated using any suitable drive mechanism, and any linkage thereto, adapted for specific positioning of the print tray, which may include reciprocal movement. Suitable drive mechanisms are known in the art of printing and may include stepper motors or otherwise. In a preferred embodiment, to effectuate specific positioning of the print tray, movement of the print tray is sequenced with the movement and printing of the print head. Preferably, the movement of the print tray and the print head are effectuated through a controller adapted to cause the print tray to move to one or more positions, as discussed herein, so that the one or more print heads can print to a specified region of the disc.

As previously discussed, the media device may include a media component such as a recording device and/or a print assembly, each having a movable tray that extend and retract generally perpendicular to the engagement mechanism, for example, to at least one of the first and second slide members. The movable tray (e.g., engagement area) may further include a calibration portion 36, which is positioned by a known distance from an engagement axis of the movable tray for aligning the disc transport during the auto-calibration mode. The calibration portion may be an area with a known elevation transition such as a generally flat surface having an edge, a generally flat surface without an edge and/or an elevation transition, or otherwise. In one embodiment, the calibration portion of the movable tray includes a generally flat surface located about the top surface 38 of the movable tray with an edge portion 40 that is elevated from the recess within movable tray. Accordingly, once the sensor interacts with the calibration portion by initiating contact, removing contact, or otherwise, the sensor is activated. It is appreciated that the calibration portion and the sensor may be positioned respectively anywhere about the movable tray and the disc transport, such that the sensor is capable of interacting with the calibration portion. For example, in another embodiment the calibration portion may be located on the disc transport instead of along the moveable tray while the sensor may be located elsewhere (e.g., engagement area, or otherwise), such that the calibration portion and the sensor are capable of interacting, preferably through the movement of at least one of the disc transport and the calibration portion.

It is appreciated that the sensor and the calibration portion may be positioned such that physical contact therebetween may not be preferred. As such, an optical sensor may be utilized interact with the calibration portion. As such, the optical sensor enables the media device to allow for additional configurations, (e.g., placement, or otherwise), of the calibration components (e.g., sensor and/or calibration portion). In one embodiment, the calibration portion may be mounted to the disc transport and the activating sensor may be positioned about a media component. In another embodiment, the sensor may be positioned about the movable tray of a media component and the calibration portion may be positioned about the disc transport.

As previously mentioned, the media device may include one or more disc storage regions (e.g., engagement areas) for storing discs prior to and/or after processing of the one or more discs. The storage regions may include a disc storage receptacle 42 that provides storage for a plurality of discs stacked within generally vertical walls or rods. The storage receptacle may further include a calibration portion 44, which is a known distance from its engagement area (e.g., the center of the engagement area) for aligning the engagement mechanism of the disc transport along an engagement axis during the auto-calibration mode. In one embodiment, the calibration portion of the receptacle may include a generally flat surface 46 with an edge portion 48 (e.g., shelf portion, elevated portion, transition portion, or otherwise). For example, when included, the edge portion defines the entire calibration portion, which as discussed herein, is a known distance from the center of the engagement area such that upon activation of the sensor (e.g., sensor drops off the edge portion) the calibration setting can be determined. Preferably, the calibration portion of the receptacle is located along the base 50 of the storage receptacle. Similarly to the movable recording tray, it is appreciated that the location of the calibration portion and the sensor may be positioned respectively anywhere about the storage receptacle and the disc transport, such that the sensor is capable of interacting with the calibration portion. For example, the calibration portion could be located about the disc transport instead of about the storage receptacle.

In one exemplary method, the operation of the media device is demonstrated as follows. Upon the first activation of the media device, preferably during each activation of the media device, a calibration feature may be initiated automatically by the media device or manually by the user via a user interface. To locate an engagement area the disc transport will move along a first slide member in at least one axis (e.g., rotationally, horizontally, vertically, diagonally, or otherwise, or any combination thereof, as discussed herein. The media device handles the disc media by moving the disc transport to a preprogrammed location to engage or disengage the disc. The disc is typically in a fixed location, which must be engaged with relative accuracy.

In one aspect of the calibration feature, the disc transport, more specifically, the engagement mechanism is calibrated with respect to an engagement area of the disc storage receptacle, more specifically an engagement axis therein, using a sensor. As previously mentioned, the storage receptacle may further include a calibration portion that is positioned about a known distance from the engagement axis of the disc storage receptacle. Upon initiation of the calibration feature, the disc transport moves towards the storage receptacle so as to become positioned thereabove, (Y₀, Z₀). The (Y₀, Z₀), location may be positioned anywhere that the disc transport is movable to, preferably, the location is generally proximate to the engagement axis of an engagement area. The (Y₀, Z₀) location is an arbitrary starting location for determining the calibration offset required to align the engagement mechanism along the engagement axis of the storage receptacle.

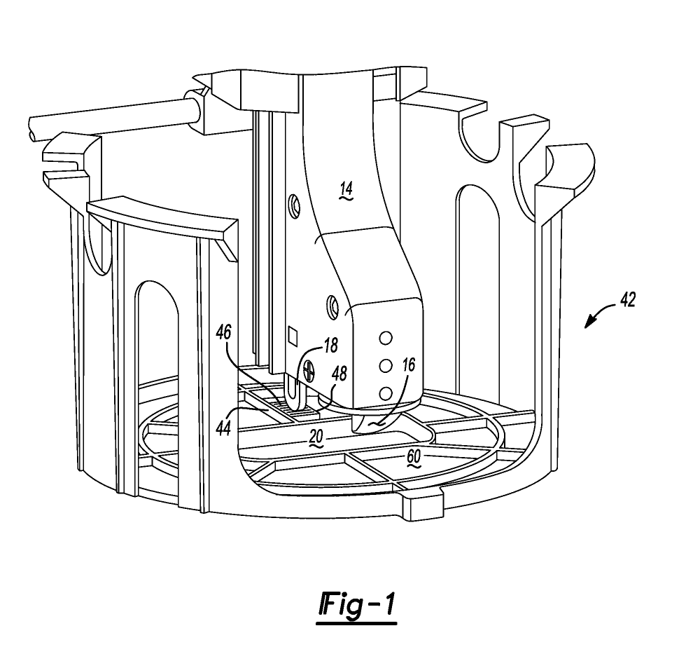

Upon reaching the arbitrary starting location (Y₀, Z₀), the disc transport is lowered generally vertically along a Z-axis within the empty disc storage receptacle until the sensor interacts with the calibration portion of the storage receptacle and becomes activated, first activation location (Y₀, Z₁), (FIG. 1). For example, in one embodiment, the activation occurs once the sensor is pushed upward from the surface of the receptacle calibration portion as the disc transport continues to move downward. After the sensor is activated, the disc transport moves generally horizontally along the surface in the Y-axis until the sensor reaches the calibration position, re-activation location (Y₀, Z₀), (FIG. 2). For example, in one embodiment, re-activation occurs once the sensor reaches the calibration position and/or drops off the surface edge of the receptacle calibration portion (typically for use with a mechanical sensor, however, it is appreciated that an optical sensor or otherwise may be used). Upon re-activation, the sensor signals the controller to stop the movement of the disc transport.

Optionally or as an alternative, the auto-calibration feature may also include the calibration of the disc transport with respect to a media component. For example, the calibration of one or more media components will be discussed referring to a recording device, however, it is appreciated that the calibration of the print assembly or the like is accomplished in a likewise manner. The recording device has a movable tray that may further include a calibration portion. The calibration portion of the movable recording tray may be located proximate to the engagement area or otherwise and is positioned such that the calibration portion is a known distance from the engagement axis of the movable recording tray. Upon initiation of the calibration feature, the disc transport moves towards the recording device such that the engagement mechanism is generally positioned above the fully extended movable recording tray, starting location (Y₀, Z₀). Similar to the calibration of the disc transport with respect to the disc storage receptacle, the (Y₀, Z₀) location may be positioned anywhere the disc transport can move to, preferably, the location is generally proximate to the engagement axis of the engagement area, (e.g. movable tray). The (Y₀, Z₀) location is an arbitrary starting location for determining the calibration offset required to align the disc transport along the engagement axis of the movable recording tray.

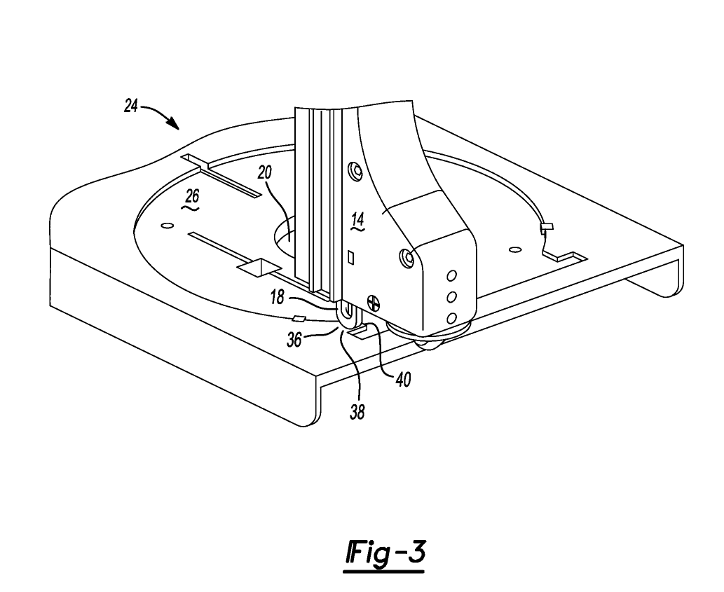

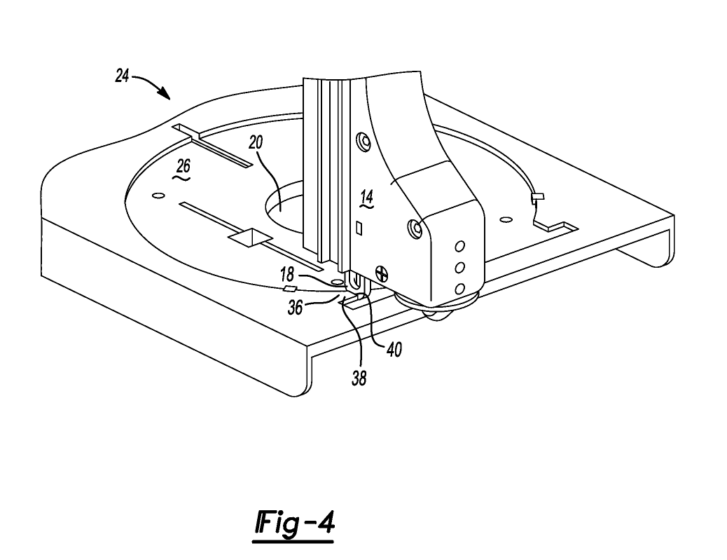

Upon reaching the arbitrary starting location (Y₀, Z₀), the disc transport is lowered along a Z-axis towards the movable recording tray, which is in an extended “open” position. The disc transport moves generally vertically along the Z-axis until the sensor interacts with the calibration portion of the movable recording tray and becomes activated, first activation (Y₀, Z₁), (FIG. 3). For example, in one embodiment, the activation occurs once the sensor is pushed upward from the surface of the movable tray calibration portion as the disc transport continues to move downward. After the sensor is activated, the disc transport moves generally horizontally along the Y-axis until the sensor reaches the calibration portion of the movable tray, re-activation location (Y1, Z1), (FIG. 4). For example, in one embodiment, re-activation occurs once the sensor interacts with the calibration position (e.g., drops off the surface edge of the calibration portion of the movable tray, or otherwise), depending on what type of sensor is used. Upon re-activation, the sensor signals the controller to stop the movement of the disc transport.

The controller stores the positional coordinates and movement offset initiation of the calibration mode, upon one or more activations of the sensor, or otherwise to determine a calibration setting during the calibration mode. Once the calibration feature is initiated, the controller stores the starting coordinate of the disc transport, (Y₀, Z₀), and measures the movement along the Z-axis until the sensor activates, (Y₀, Z₁). Upon sensor activation, the controller stores a first activation coordinate, (Y₀, Z₁), and determines a Z-axis offset distance [Z-offset=|(Y₀,Z₁)−(Y₀,Z₀)|], which is the distance the disc transport moved along the Z-axis from the starting coordinate to the first activation coordinate. The controller then moves the disc transport along the Y-axis until the sensor is re-activated upon sensing the calibration portion, (Y₁, Z₁). Once the sensor is re-activated, the controller stores the second activation coordinate, (Y₁, Z₁) and determines a Y-axis offset distance [Y-offset=|(Y₁,Z₁)−(Y₀,Z₁)|], which is the distance the disc transport moved along the Y-axis from the sensor's first activation coordinate to the sensor's second activation coordinate. It is appreciated that absolute values of the resultant coordinates are used in determining the distance moved based on the direction of movement by the disc transport, the one or more media components, or any combination thereof.

Once the controller stops the movement of the disc transport after receiving the re-activation signal, the controller determines the calibration setting based on the arbitrary starting location, (Y₀, Z₀), the Z-axis and Y-axis calibration offsets, and the known distance, (ΔY_{E}, ΔZ_{E}), which is the distance between the calibration portion, (Y₁, Z₁) and the engagement axis, (Y_{E}, Z_{E}). Once a calibration setting is determined and stored by the controller, the controller configures the media device to align the engagement mechanism of the calibrated disc transport to the desired calibrated engagement axis of the engagement area. After calibrating the disc transport to one or more of the storage receptacle, the one or more media components, or otherwise, each is now ready to receive storage discs. Thereafter, the disc transport is configured to engage or disengage storage discs to the desired calibrated engagement area, thereby correcting the previous alignment issues.

In another embodiment, the one or more media components are calibrated to determine an optimal extension position, which would generally align the engagement area of the movable tray with an engagement axis and preferably with the engagement mechanism of the disc transport thereabove. As such, the media device of the present invention comprises a disc transport associated with an engagement mechanism, a movable tray associated with a media component, a calibration feature for aligning the movable tray with the disc transport, and a controller for controlling the functions of the media device. In a preferred embodiment, the disc transport further includes a sensor for sensing conditions of the media device and for relaying these conditions to the controller to control the media device, respectively. The movable tray includes a calibration portion, (Y₁, Z₁), and a disc engagement area, (Y_{E}, Z_{E}), that are at a predetermined, preferably fixed, distance from each other, [(ΔY_{E},ΔZ_{E})=|(Y_{E},Z_{E})−(Y₁,Z₁)|].

Upon initiation of the calibration feature, the disc transport moves towards the movable tray of the media component so as to become generally positioned above the fully extended movable tray, (Y₀, Z₀). Similar to the calibration of the disc transport with respect to the disc storage receptacle and/or the recording/printing device, the (Y₀, Z₀) location may be positioned anywhere the disc transport can move to, preferably, the location is generally proximate to the engagement area of the movable recording tray. The (Y₀, Z₀) location is an arbitrary starting location for determining the calibration offset required for optimal extension of the movable tray, so as to align the engagement area of the movable tray with the disc transport located thereabove, along an engagement axis.

Upon reaching the arbitrary starting location (Y₀, Z₀), the disc transport is lowered along a Z-axis towards the movable tray, which is in an extended position until the sensor is activated, (Y₀, Z₁). Activation occurs once the mechanical sensor contacts the calibration portion of the movable tray. Again, as discussed above, the main function of the calibration portion is to create a height transition usually from a higher level to lower level. Upon activation of the sensor, the movable tray is either extended or retracted depending on where the sensor contacts the movable tray. The movable tray moves along the horizontal axis until the sensor reaches the edge of the calibration portion and drops off the height transition. Once the sensor drops off the calibration portion, the mechanical sensor is reactivated, (Y₀, Z₁), and the controller records the distance traveled by the moveable tray between the two activations of the sensor, [Z-offset=(Y₀,Z₁)−(Y₀,Z₀) and Y-offset=(Y₁, Z₁)−(Y₀, Z₁)].

In yet another embodiment, the disc transport has an optical sensor that interacts with the movable tray as it extends or retracts. In this respect, the sensor does not need to have physical contact with the movable tray to activate the sensor. The optical beam from the sensor projects onto the movable tray as the moveable tray moves. As such, this enables the calibration portion to be generally flat with or without a height transition to activate the sensor. Once the sensor beam interacts with the calibration portion of the movable tray the optical sensor activates. Upon the first sensor activation, the controller can determine the calibration setting from the known height of the optical sensor with respect to the calibration portion, which is positioned about the movable tray in a predetermined, preferably fixed, distance from the engagement area. Once the calibrating portion is located, the controller determines the optimal extension of the movable tray, which would align the engagement area of the movable tray along an engagement axis. Thereafter, the movable tray is calibrated to open to the optimal extension position for future disc engagement and disengagement needs therein.

It is appreciated that a media component may be a rotating disc carousel that is in communication with the disc transport. The disc carousel may include a plurality of disc storage receptacles and an auto-calibration feature, which can align a first storage receptacle with an engagement axis, the disc transport, or otherwise using a sensor and a calibration portion.

For example in one embodiment, the media device may further comprise a disc carousel adapted for supplying and storing one or more discs. Similar to the method of auto-calibrating the movable tray, the disc carousel is configured for to rotate about a generally vertical axis to activate the sensor. The activation may occur upon the interaction of the sensor with respect to the calibration portion, which as discussed above, both may be respectively positioned about any location so long as the sensor and the calibration portion are capable of interaction and either the sensor or the calibration portion is positioned about the disc carousel and/or the disc transport. Preferably, the calibration portion is located about the disc carousel and the sensor is located elsewhere (e.g., disc transport), wherein the sensor can interact with the calibration portion. Once the calibration portion is located and the sensor activated, the controller of the media device can determine how much further rotation of the disc carousel may be needed to position the engagement area of a first storage receptacle along an engagement axis for engagement and/or disengagement of a disc therein. Thereafter, the disc carousel is calibrated to align the engagement area of a first disc receptacle for future engagement and/or disengagement of on or more discs by the engagement mechanism of the disc transport, which is generally positioned thereabove.

Furthermore, it is contemplated that calibration along one or more axes, (e.g. X-axis, R-axis, or otherwise), is appreciated for the disc transport, the one or more media device components, or otherwise in additional embodiments having additional axes of movement than those discussed herein.

Once the conditions of misalignment are determined, the controller modifies the settings of the misaligned component and stores the modified conditions as a calibration setting, which corrects the misalignment between the component such as the disc transport, the movable tray of movable tray, or otherwise and the respective engagement axis.

Once calibrated, a user selects one or more tasks to be performed by the device, via a user interface. As previously mentioned, such tasks may include recording to a disc, printing to a disc, or both. The user interface may be located proximate to the device or remote to the device (e.g., via a network connection, Internet or otherwise). It should also be appreciated that the user interface may comprise an integral component of the media device, (e.g., located externally or otherwise). Prior to assignment of a task to be performed by the media device, the user places one or more discs at the disc storage region. Optionally, the amount of discs placed in the disc storage region corresponds to the desired selected storage devices the user wishes to perform tasks to.

Through the user Interface, the user selects one or more tasks to be performed to one or more discs. Often, as discussed below, the task includes both the recording and printing of information. For example, the tasks may include transferring data from a source to one or more discs, in a digital format. In addition, the tasks may also include printing to the recorded discs, which advantageously corresponds to the information transferred to the disc. Once the tasks have been selected, one or more signals are transferred to the controller of the media device to effectuate synchronized operation of the print device corresponding to the tasks requested.

For example, in one method of operation, upon transmission of the task signal to the media device, the disc transport moves along the first slide member to the disc storage region, wherein if already calibrated, the engagement mechanism is positioned over the holes of the one or more discs located therebelow in the supply region, which is adapted to receive and/or store a plurality of discs. The engagement mechanism is lowered along the second slide member until the flanges, extending from the engagement fingers, become generally flush with the top disc residing in the supply region. The engagement fingers are then separated so that the top disc is separated from the adjacent disc residing in the one or more supply regions.

The disc is moved along the first slide member to one of the recording devices. Preferably, the recording tray of the recording device is extended to a calibrated position, so that the center portion of the disc attached to the engagement mechanism is substantially aligned with the center of the recording tray of the recording device. The engagement mechanism is then lowered along the second slide member proximate to the recording tray and disengages the disc. Upon placement of the disc into the recess formed on the recording tray, the engagement mechanism returns to an original position and the recording tray retracts into the recording device, wherein information is then recorded onto the disc. The operation of transferring discs to the plurality of recording devices is repeated until each recording device is in use; the entire task is complete, or otherwise.

Upon completion of recordation of data to the disc, the recording tray extends and the disc engagement mechanism lowers and once again engages the disc and raises it to the original position. The disc printing tray then moves into an extending position and the disc transport, if necessary, is calibrated so to align the center of the disc with the center of the recess formed in the disc-printing tray. The engagement mechanism then lowers the disc onto the print tray in a similar fashion that was performed with the disc-recording device. Once aligned, the disc transport returns the engagement mechanism to an upward portion.

Upon completion of the printing to the disc, and advantageously during recordation of data to the disc located in the recording device, the print assembly tray extends to its extended calibrated position. The disc transport then aligns itself with the disc located in the print tray, if necessary, and engages the completed disc. The disc is then transported to the one of the one more storage regions.

It should be appreciated that this cycle continues until the all of the selected tasks have been completed or the discs from the disc storage region has been exhausted.

Unless stated otherwise, dimensions and geometries of the various structures depicted herein are not intended to be restrictive of the invention, and other dimensions or geometries are possible. Plural structural components can be provided by a single integrated structure. Alternatively, a single integrated structure might be divided into separate plural components. In addition, while a feature of the present invention may have been described in the context of only three of the illustrated embodiments, such feature may be combined with one or more other features of other embodiments, for any given application. It will also be appreciated from the above that the fabrication of the unique structures herein and the operation thereof also constitute methods in accordance with the present invention.

The preferred embodiment of the present invention has been disclosed. A person of ordinary skill in the art would realize however, that certain modifications would come within the teachings of this invention. Therefore, the following claims should be studied to determine the true scope and content of the invention.

1. An auto-calibrating component of a media device apparatus comprising:
a disc transport movable along at least one axis, the disc transport including an engagement mechanism for selective engagement of at least one disc;
one or more media device components including:
an engagement area having an engagement axis, the engagement area adapted to receive the at least one disc for selective engagement thereof; and
a calibrating device for aligning the engagement mechanism with the engagement axis, the calibrating device including:
a first member associated with the disc transport and a second member associated with the media device component, wherein the first member, the second member, or a combination of both is moved from a starting position until a calibration position is sensed thereby defining a calibration offset, the calibration position being a known distance from the engagement area;
wherein a calibration setting is stored such that the media device apparatus is configured to align the engagement mechanism of the disc transport with the alignment axis upon engagement of the at least one disc in the engagement area.

2. The apparatus of claim 1, wherein the first member is a sensor configured to sense a condition of the disc transport, the media device component, or both and to provide a condition signal corresponding to the sensed condition.

3. The apparatus of claim 2, further comprising a control unit adapted for receiving the condition signal from the sensor and for controlling the functions of the disc transport relative to the sensed condition.

4. The apparatus of claim 1, wherein the one or more media device components are a disc storage receptacle, a disc carousel, a recording device, or a print assembly.

5. The apparatus of claim 1, wherein the controller determines a calibration setting based upon the movement by the first member, the second member, or both with respect to the sensed calibration position and the known distance from the calibration position to the engagement area.

6. The apparatus of claim 1, wherein the second member is located about a movable tray of the recording device or the print assembly or a base of the disc storage receptacle or the disc carousel.

7. The apparatus of claim 1, wherein the calibration position is a generally flat surface, an edge portion having a height transition, or both.

8. A method for auto-calibrating a media device comprising:
providing a disc transport for movement along at least one axis, one or more media device components having an engagement area adapted to receive at least one disc, a controller for controlling the functions of the media device and a calibrating device for aligning at least one of the disc transport and the one or more media device components along an engagement axis, wherein the disc transport includes an engagement mechanism for selective engagement of at least one disc, and the calibrating device includes a first member associated with the disc transport and a second member associated with the one or more media device components;
calibrating at least one of the disc transport and the one or more media device components that is in mis-alignment with the engagement axis by:
moving the first member, the second member, or a combination of both from an arbitrary position until a calibration position is sensed to as to determine a calibration setting; and
storing the calibration setting so that upon election to engage the at least one disc located in the engagement area, the disc transport, the one or more media device components, or a combination of both is automatically moved such the engagement mechanism and the one or more media device components are in alignment along the engagement axis.

9. The method of claim 8, wherein the step of determining the calibration setting based upon the movement by the first member, the second member, or both with respect to the sensed calibration position and the known distance from the calibration position to the engagement area.

10. The method of claim 8, wherein the first member is a sensor configured to sense a condition of the disc transport, the media device component, or both and to provide a condition signal corresponding to the sensed condition.

11. The method of claim 10, wherein the second member is located about a movable tray of a recording device or a print assembly or a base of a disc storage receptacle or a disc carousel.

12. The method of claim 10, wherein the step of calibrating further comprises the step of moving the sensor along a first axis until the sensor senses a first calibration position and wherein the sensor provides a first calibration position signal to the controller to determine the second calibration position.

13. The method of claim 12, wherein the step of calibrating further comprises the step of moving the sensor along the second axis until the sensor senses a second calibration position and wherein the sensor provides a second calibration position signal to the controller to determine the second calibration position, which is at a known distance from the engagement area.

14. The method of claim 13, wherein the determining a calibration setting further comprises the step of processing the first calibration position, the second calibration position, and the known distance between the second calibration position and the engagement area to align the disc transport along the engagement axis.

15. The method of claim 8, wherein the calibration position is a generally flat surface, an edge portion having a height transition, or both.

16. An auto-calibrating media device apparatus comprising:
a disc transport movable along at least one axis, the disc transport including an engagement mechanism for selective engagement of at least one disc;
one or more media device components including:
an engagement area having an engagement axis; and
a calibrating device for aligning the engagement mechanism of the disc transport, which is mis-aligned with a first engagement area having a first engagement axis, the calibrating device including:
a first member associated with the disc transport and a second member associated with the one or more media device components, wherein the first member moves along a first axis and upon a first calibration position being sensed, the disc transport moves along a second axis until a second calibration position is sensed, which is at a known distance from the first engagement area;
wherein a calibration setting is stored such that the media device apparatus is configured to automatically align the engagement mechanism of the disc transport with the first alignment axis upon election to engage the at least one disc in the first engagement area.

17. The apparatus of claim 16, wherein the first member is a sensor configured to sense a condition of the disc transport and to provide a condition signal corresponding to the sensed condition.

18. The apparatus of claim 16, further comprising a control unit for controlling the functions of the disc transport, wherein the control unit is in communication with the disc transport and the sensor.

19. The apparatus of claim 16, wherein the one or more media device component is a disc storage receptacle, a disc carousel, a recording device, or a print assembly, each adapted to receive at least one disc.

20. The apparatus of claim 16, wherein the calibration position is a generally flat surface, an edge portion having a height transition, or both.
